(19) United States
(12) Patent Application Publication
(10) Pub. No.: US 2025/0319921 A1
(43) Pub. Date: Oct. 16, 2025

(54) FOLDING HANDCART

(71) Applicant: Qiang CHEN, Shenzhen (CN)

(72) Inventor: Qiang CHEN, Shenzhen (CN)

(21) Appl. No.: 18/937,063

(22) Filed: Nov. 5, 2024

(30) Foreign Application Priority Data
Apr. 15, 2024 (CN) 2024207646057

(51) Int. Cl. B62B 7/08; B62B 9/20

(52) U.S. Cl. CPC B62B 7/083; B62B 9/206

(57) ABSTRACT

A folding handcart includes a frame assembly including: four upright rods, a bottom frame assembly, a front-rear arm assembly and a side enclosure assembly. By connecting the front-rear arm assembly to the bottom frame assembly, the front-rear arm assembly has a certain inclined angle relative to the ground, which is close to an angle of an everyday seat backrest, significantly enhancing comfort when children are riding. Meanwhile, the inclined angle of the front-rear arm assembly makes an opening length of the folding handcart greater than a bottom length, making it easier to load items and providing more storage space. When the folding handcart is folded, the front-rear arm assembly can close, thereby forming a shape similar to a suitcase, which greatly improves neatness of product storage; and the push rod can be erected to serve as a towing handle for dragging, thereby enhancing the convenience of product handling.

### CROSS-REFERENCE TO RELATED APPLICATION

This application claims priority to Chinese Patent Application No. 2024207646057, filed Apr. 15, 2024, which is herein incorporated by reference in its entirety.

### TECHNICAL FIELD

The disclosure relates to the field of handcart technologies, and more particularly to a folding handcart.

### BACKGROUND

Child handcarts (also referred to as baby strollers) are not only the favorite walking vehicles for children but also essential items for mothers when taking their children shopping. However, according to growth and usage purposes of children, the child handcarts can be divided into many types. According to Japanese national standards, the child handcarts can basically be divided into type A and type B. Generally speaking, the type A is a spacious and comfortable pushchair that can be used from 2 months old; and the type B is a lightweight and portable pushchair that can be used from 6 months old.

Current child handcarts suitable for children are mostly small in capacity and can carry fewer items in actual use, which is not convenient when traveling with children. Moreover, the volume of the child handcarts after folding is relatively large, making it difficult to carry alone, and the usage effect is still not ideal.

### SUMMARY

A purpose of the disclosure is to provide a folding handcart, to solve above problems in the related art.

In order to achieve above purpose, the disclosure provides the following technical solutions. The folding handcart includes a frame assembly. The frame assembly includes: four upright rods, a bottom frame assembly, a front-rear arm assembly and a side enclosure assembly. The bottom frame assembly includes: a right lower bottom bracket, a left lower bottom bracket, a right upper bottom bracket, and a left upper bottom bracket. Two limit connection iron fittings are disposed between the right lower bottom bracket, the left lower bottom bracket, the right upper bottom bracket and the left upper bottom bracket. Ends of the right lower bottom bracket, the left lower bottom bracket, the right upper bottom bracket and the left upper bottom bracket are rotatably connected to the two limit connection iron fittings by rotation shafts, other ends of the right lower bottom bracket, the left lower bottom bracket, the right upper bottom bracket and the left upper bottom bracket are rotatably connected to insides of the four upright rod, and the ends of the right lower bottom bracket and the left lower bottom bracket near the two limit connection iron fittings are fixedly provided with linkage gears meshed with each other.

In an embodiment, a top of each limit connection iron fitting defines two notches, the ends of the right upper bottom bracket and the left upper bottom bracket near the two limit connection iron fittings are welded with limit pins, and the limit pins are disposed inside the notches of the two limit connection iron fittings respectively.

In an embodiment, the right upper bottom bracket and the left upper bottom bracket are respectively provided with rotatable seat brackets, and insides of the right upper bottom bracket and the left upper bottom bracket are welded with seat limit pins. The seat limit pins are capable of supporting the rotatable seat brackets.

In an embodiment, the front-rear arm assembly includes: upper connecting members inserted in tops of the four upright rods, four lower connecting members inserted in bottoms of the four upright rods, an upper transverse rod fixedly disposed between adjacent two upper connecting members, a lower transverse rod fixedly disposed between adjacent two lower connecting members, and a backrest board fixedly disposed between the upper transverse rod and the lower transverse rod which are arranged upper and lower.

In an embodiment, the side enclosure assembly includes: a left enclosure rod, a right enclosure rod and circular rotating members. Each of the left enclosure rod and the right enclosure rod is a tube bent into a U-shape, the left enclosure rod and the right enclosure rod are rotatably connected to the upper connecting members of the front-rear arm assembly via rotation shafts, ends of the left enclosure rod and the right enclosure rod are connected to the circular rotating members, and two circular rotating members are in contact with each other and rotatably connected to each other via a rotation shaft. An outer end of each of the left enclosure rod and the right enclosure rod facing away the circular rotating members are fixedly provided with a foam pipe.

In an embodiment, bottoms of the four lower connecting members are fixedly provided with two first wheels and two second wheels respectively.

In an embodiment, two upper connecting members are connected to a pull rod assembly.

In an embodiment, two lower connecting members under the other two upper connecting members are connected to a push rod assembly.

In the above technical solutions, the disclosure has the following beneficial effects.

1. By connecting the front-rear arm assembly to the bottom frame assembly, the front-rear arm assembly has a certain inclined angle relative to the ground, which is close to an angle of an everyday seat backrest, significantly enhancing comfort when children are riding. At the same time, the inclined angle of the front-rear arm assembly makes an opening length of the folding handcart greater than a bottom length, making it easier to load items and providing more storage space.

2. When the folding handcart is folded, the front-rear arm assembly can close, thereby forming a shape similar to a suitcase, which greatly improves the neatness of product storage. After the folding handcart is folded, the push rod can be erected to serve as a towing handle for dragging, thereby enhancing the convenience of product handling.

### BRIEF DESCRIPTION OF DRAWINGS

In order to provide a clearer explanation of embodiments of the disclosure or the technical solutions in the related art, the accompanying drawings required for the embodiments are briefly introduced. It is apparent that the accompanying drawings described below are only some of the embodiments described in the disclosure. For those skilled in the art, other drawings can also be obtained based on these accompanying drawings.

FIG. 1 illustrates a schematic structural diagram of a folding handcart in the disclosure.

FIG. 2 illustrates a schematic diagram of the folding handcart in a folding state in the disclosure.

FIG. 3 illustrates a schematic diagram of the folding handcart in a folding-towing state in the disclosure.

FIG. 4 illustrates a schematic structural diagram of a bottom frame assembly of the folding handcart in the disclosure.

FIG. 5 illustrates another schematic structural diagram of the bottom frame assembly of the folding handcart in the disclosure.

FIG. 6 illustrates a schematic structural diagram of a front-rear arm assembly of the folding handcart in the disclosure.

Description of reference numerals: 1: upright rod; 2: right lower bottom bracket; 3: left lower bottom bracket; 4: right upper bottom bracket; 5: left upper bottom bracket; 6: limit connection iron fitting; 7: notch; 8: limit pin; 9: linkage gear; 10: rotatable seat bracket; 11: seat limit pin; 12: upper connecting member; 13: lower connecting member; 14: upper transverse rod; 15: lower transverse rod; 16: backrest board; 17: left enclosure rod; 18: right enclosure rod; 19: circular rotating member; 20: first wheel; 21: second wheel; 22: pull rod assembly; 23: push rod assembly; 24: foam pipe; 25: rotation shaft; 26: rotation shaft; 27: rotation shaft.

### DETAILED DESCRIPTION OF EMBODIMENTS

In order to enable those skilled in the art to better understand the technical solutions of the disclosure, a further detailed introduction is made to the disclosure in conjunction with the accompanying drawings.

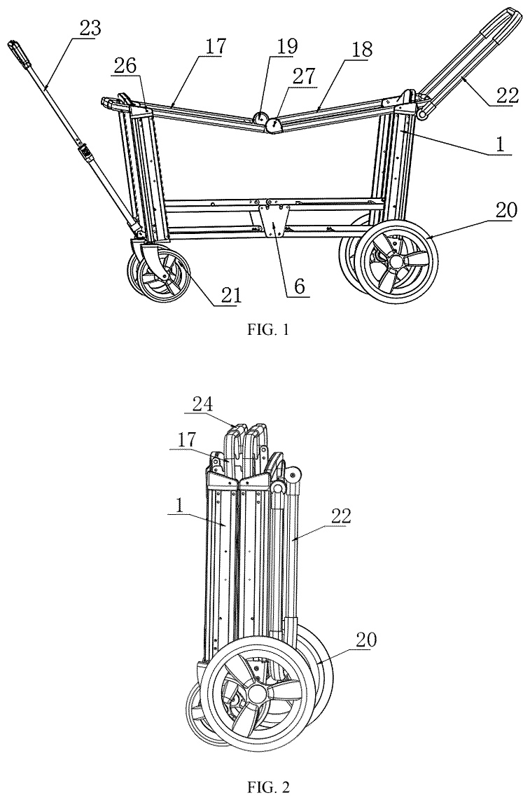

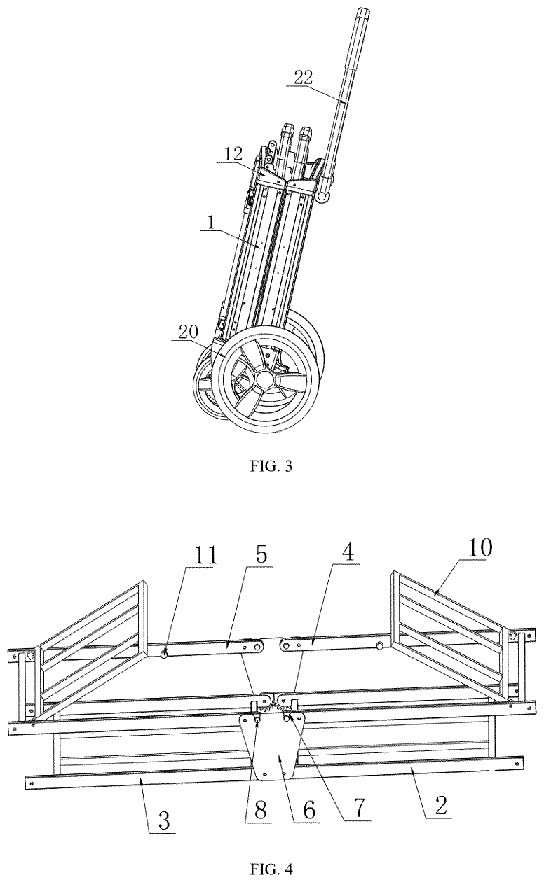

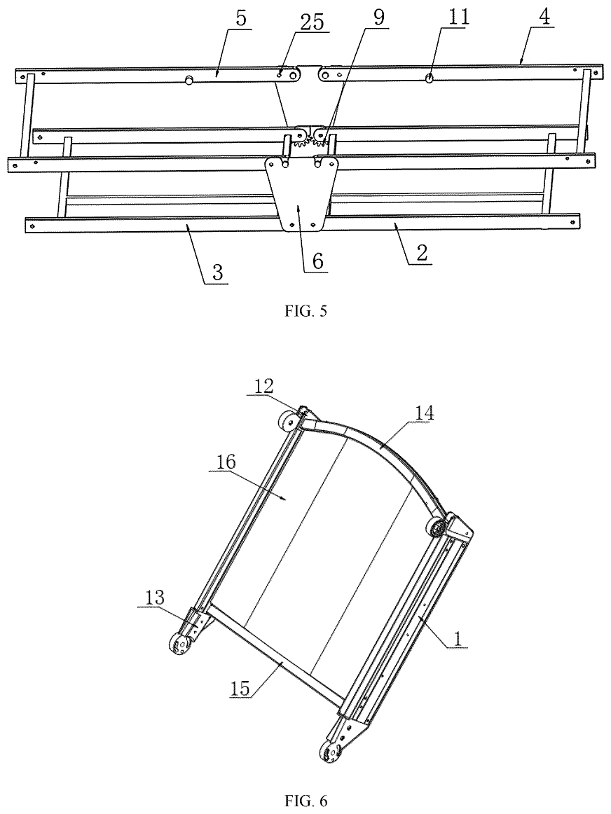

The disclosure provides a folding handcart as shown in FIG. 1 to FIG. 6. The folding handcart includes a frame assembly. The frame assembly includes: four upright rods 1, a bottom frame assembly, a front-rear arm assembly and a side enclosure assembly.

The bottom frame assembly includes: a right lower bottom bracket 2, a left lower bottom bracket 3, a right upper bottom bracket 4, and a left upper bottom bracket 5. The right lower bottom bracket 2, the left lower bottom bracket 3, the right upper bottom bracket 4 and the left upper bottom bracket 5 are connected through two limit connection iron fittings 6. An end of the left upper bottom bracket 5 near the right upper bottom bracket 4 is welded with limit pins 8. When the limit pins 8 fit in notches 7 of the limit connection iron fittings 6, the left upper bottom bracket 5 can be prevented from continuing to move downward, thereby achieving the function of supporting the bracket in an unfolded and flat state under load. An end of the right upper bottom bracket 4 near the left upper bottom bracket 5 is also welded with limit pins 8, and the limit pins 8 fit in notches 7 of the limit connection iron fittings 6, thereby achieving the function of supporting the bracket in an unfolded and flat state under load. An end of the left lower bottom bracket 3 near the right lower bottom bracket 2 is welded with linkage gears 9, and an end of the right lower bottom bracket 2 near the left lower bottom bracket 3 is also welded with linkage gears 9. The linkage gears 9 welded on the left lower bottom bracket 3 and the linkage gears 9 welded on the right lower bottom bracket 2 are meshed with each other to keep the right lower bottom bracket 2, the left lower bottom bracket 3, the right upper bottom bracket 4 and the left upper bottom bracket 5 synchronized during movement. The right upper bottom bracket 4 and the left upper bottom bracket 5 are provided with rotatable seat brackets 10 respectively, and the right upper bottom bracket 4 and the left upper bottom bracket 5 are welded with seat limit pins 11 respectively, providing support for the rotatable seat brackets 10 when the rotatable seat brackets 10 are laid flat, thereby preventing the rotatable seat brackets 10 from moving further downward. During use of the folding handcart, the rotatable seat brackets 10 serve as a seat. When the folding handcart needs to carry items, the rotatable seat brackets 10 can be folded upward, exposing the right lower bottom bracket 2 and the left lower bottom bracket 3, which then serve as a cargo base, thereby obtaining a larger load space.

The front-rear arm assembly includes: upper connecting members 12, lower connecting members 13, upper transverse rods 14, lower transverse rods 15 and backrest boards 16. The upper connecting members 12 are inserted and riveted in top ends of the upright rods 1, and the lower connecting members 13 are inserted and riveted in bottom ends of the upright rods 1. Every two adjacent upper connecting members 12 are connected by a corresponding upper transverse rod 14, and every two adjacent lower connecting members 13 are connected by a corresponding lower transverse rod 15 to form a complete front-rear arm frame. The two backrest boards 16 are connected to the front-rear arm frames respectively to form the front-rear arm assembly completely. The front-rear arm assembly is connected to the bottom frame assembly, making the front-rear arm assembly have an inclined angle relative to the ground, which is close to an angle of an everyday seat backrest, significantly enhancing comfort when children are riding. Meanwhile, the inclined angle of the front-rear arm assembly makes an opening length of the folding handcart greater than a bottom length, making it easier to load items and providing more storage space.

The side enclosure assembly includes: a left enclosure rod 17 and a right enclosure rod 18. Each of the left enclosure rod 17 and the right enclosure rod 18 is a tube bent into a U-shape, the left enclosure rod 17 and the right enclosure rod 18 are rotatably connected to the four upper connecting members 12 of the front-rear arm assembly respectively. The upper connecting members 12 clamp the left enclosure rod 17 and the right enclosure rod 18 in a clamp manner, ends of the left enclosure rod 17 and the right enclosure rod 18 facing away the upper connecting members 12 are connected to circular rotating members 19 respectively. Two circular rotating members 19 which are in contact with each other are connected to form a rotatable point. The design of the side enclosure assembly significantly reduces a lateral swing of the side enclosures in a horizontal plane, which notably enhances the safety for children when they are riding and also markedly improves the durability of the folding handcart. A middle of a turning point of each of the left enclosure rod 17 and the right enclosure rod 18 is sleeved with a foam pipe 24. After the folding handcart is folded, the foam pipes 24 on the left enclosure rod 17 and the right enclosure rod 18 serve as handles for lifting the folding handcart.

Other main features of the folding handcart are as follows. After the folding handcart is folded, the front-rear arm assembly can close, thereby forming a shape similar to a suitcase, which greatly improves the neatness of product storage. After the folding handcart is folded, the push rod can be erected to serve as a towing handle for dragging, thereby enhancing the convenience of product handling. The embodiment of the disclosure specifically solves problems in the related art that most strollers suitable for children to use have a smaller capacity and can carry fewer items, which is not convenient when taking children out. Moreover, a volume of the strollers after folding is relatively large, making it difficult to carry alone, and the usage effect is still not satisfactory.

The above descriptions only illustrate certain exemplary embodiments of the disclosure, undoubtedly, for those skilled in the art, without deviating from the spirit and scope of the disclosure, various modifications can be made to the described embodiments in different ways. Therefore, the above accompanying drawings and descriptions are essentially illustrative and should not be understood as limiting the scope of the claims of the disclosure.

What is claimed is:

1. A folding handcart, comprising:
a frame assembly, comprising: four upright rods (1), a bottom frame assembly, a front-rear arm assembly and a side enclosure assembly;
wherein the bottom frame assembly comprises: a right lower bottom bracket (2), a left lower bottom bracket (3), a right upper bottom bracket (4), and a left upper bottom bracket (5); two limit connection iron fittings (6) are disposed between the right lower bottom bracket (2), the left lower bottom bracket (3), the right upper bottom bracket (4) and the left upper bottom bracket (5); ends of the right lower bottom bracket (2), the left lower bottom bracket (3), the right upper bottom bracket (4) and the left upper bottom bracket (5) are rotatably connected to the two limit connection iron fittings (6) by rotation shafts (25); other ends of the right lower bottom bracket (2), the left lower bottom bracket (3), the right upper bottom bracket (4) and the left upper bottom bracket (5) are rotatably connected to insides of the four upright rods (1); and the ends of the right lower bottom bracket (2) and the left lower bottom bracket (3) near the two limit connection iron fittings are fixedly provided with linkage gears (9) meshed with each other.

2. The folding handcart as claimed in claim 1, wherein a top of each of the two limit connection iron fittings (6) defines two notches (7), the ends of the right upper bottom bracket (4) and the left upper bottom bracket (5) near the two limit connection iron fittings (6) are welded with limit pins (8), and the limit pins (8) are disposed inside the notches (7) of the two limit connection iron fittings (6) respectively.

3. The folding handcart as claimed in claim 1, wherein the right upper bottom bracket (4) and the left upper bottom bracket (5) are respectively provided with rotatable seat brackets (10), insides of the right upper bottom bracket (4) and the left upper bottom bracket (5) are welded with seat limit pins (11), and the seat limit pins (11) are capable of supporting the rotatable seat brackets (10).

4. The folding handcart as claimed in claim 1, wherein the front-rear arm assembly comprises: upper connecting members (12) inserted in tops of the four upright rods (1), four lower connecting members (13) inserted in bottoms of the four upright rods (1), an upper transverse rod (14) fixedly disposed between adjacent two of the upper connecting members (12), a lower transverse rod (15) fixedly disposed between adjacent two of the four lower connecting members (13), and a backrest board (16) fixedly disposed between the upper transverse rod (14) and the lower transverse rod (15) which are arranged upper and lower.

5. The folding handcart as claimed in claim 4, wherein the side enclosure assembly comprises: a left enclosure rod (17), a right enclosure rod (18) and circular rotating members (19), each of the left enclosure rod (17) and the right enclosure rod (18) is a tube bent into a U-shape, the left enclosure rod (17) and the right enclosure rod (18) are rotatably connected to the upper connecting members (12) of the front-rear arm assembly via rotation shafts (26), ends of the left enclosure rod (17) and the right enclosure rod (18) are connected to the circular rotating members (19), two of the circular rotating members (19) are in contact with each other and rotatably connected to each other via a rotation shaft (27), an outer end of each of the left enclosure rod (17) and the right enclosure rod (18) facing away the circular rotating members (19) is fixedly provided with a foam pipe (24).

6. The folding handcart as claimed in claim 4, wherein bottoms of the four lower connecting members (13) are fixedly provided with two first wheels (20) and two second wheels (21) respectively.

7. The folding handcart as claimed in claim 4, wherein two of the upper connecting members (12) are connected to a pull rod assembly (22).

8. The folding handcart as claimed in claim 7, wherein two of the four lower connecting members (13) under other two of the upper connecting members (12) are connected to a push rod assembly (23).
